(19) United States
(12) Patent Application Publication
(10) Pub. No.: US 2006/0019839 A1
(43) Pub. Date: Jan. 26, 2006

(54) Engine part coating created from polysiloxane and coating method

(76) Inventor: John A. Murray, Rialto, CA (US)

Correspondence Address: VIERING JENTSCHURA & PARTNERS, 3770 HIGHLAND AVENUE, SUITE 203, MANHATTAN BEACH, CA, 90266, US

(21) Appl. No.: 11/151,510

(22) Filed: Jun. 12, 2005

Related U.S. Application Data
(63) Continuation-in-part of application No. 11/010,817, filed on Dec. 13, 2004.
(60) Provisional application No. 60/529,950, filed on Dec. 12, 2003.

(51) Int. Cl. C10M 155/02; C09K 3/00

(52) U.S. Cl. 508/208; 508/107; 106/287.13

(57) ABSTRACT

The invention relates to an engine part coating created from polysiloxanes, said coating comprising one or more of the following compounds: cross-linked polymer made of polysiloxanes; silica; silicon-carbide-oxide; and silicon nitride. The coating can be obtained by the method steps of a) dispersing polysiloxane in a lubricant; b) bringing the lubricant into contact with certain surface areas inside an engine, c) subjecting the polysiloxane to such a temperature that it forms a silicon-containing coating on the contacted engine parts. The polysiloxane can be added to the motor oil as an additive or can be mixed directly with the fuel of a combustion engine.

### RELATED APPLICATION

A priority claim is made to a U.S. patent application Ser. No. 10/934,824, filed on Sep. 3, 2004, and a U.S. Continuation-in-part patent application Ser. No. 11/010,817 dated Dec. 13, 2004, claiming the benefit of U.S. patent application Ser. No. 10/934,824, both naming John A. Murray as inventor. The U.S. patent application Ser. No. 10/934,824, filed on Sep. 3, 2004, claims priority to the U.S. provisional patent application 60/529,950. The present application is further a U.S. Continuation-in-part Patent Application of the prior U.S. Continuation-in-part patent application Ser. No. 11/010,817 dated Dec. 13, 2004 and claims the benefit thereof. The entire teachings of all 3 applications are incorporated herein by reference.

### BACKGROUND

Conventional motor oil is used to lubricate moving parts in an engine or in other mechanical devices. Proper lubrication of engine parts is essential to preserving the life of the engine. However, there are many well-recognized limitations affecting the lubricating efficiency of motor oil. In particular, the filming properties of petroleum-based and synthetic motor oils are often inadequate, particularly in high heat areas of the motor such as the pistons, rods and cylinder walls. Without proper filming of motor oil in these areas, these parts become extremely hot [i.e., approximately 300 to 370 degrees Fahrenheit (˜149-188° C.)], which compounds suffer from the problems associated with inadequate lubrication.

For example, at elevated temperatures, the oil oxidizes and forms a glaze on the surface of the cylinder walls. The oxidized oil also coats and forms a glaze on the piston rings and piston walls. The glazing of these surfaces compromises the proper sealing of the combustion chamber, which creates increased surface tension and reduces compression resulting in lower oxidation of the fuel which in turn decreases horse power and fuel efficiency and increases harmful emissions.

Inadequate filming properties of conventional motor oils also result in a condition referred to as dry-start. Because the motor oil drains off of the engine parts when the engine is not running without leaving an adequate layer or film of lubricant, engine parts wear considerably each time the engine is started.

A number of additives have been developed to increase the lubricating properties of motor oil, and synthetic lubricants with enhanced lubricating properties have also been developed for use in lubricating engines.

### SUMMARY

Polysiloxanes in general, in particular polyether- or polyester-modified polydialkylsiloxanes can be readily mixed with a lubricant (e.g., lubricating oil), fuel or other petroleum-based products, and the resulting mixture can be in the form of a stable dispersion or suspension having lubricating properties exceeding those of existing fuel-additive combinations and existing synthetic lubricants.

More specifically, it has been discovered that a dispersion of the polyether- or polyester-modified polydialkylsiloxane in oil has enhanced filming properties, even at elevated temperatures within the engine. The enhanced filming properties provide for enhanced lubrication, providing an increased level of power while allowing engines to run more smoothly and cleanly. The polydialkylsiloxane can be added to a variety of fluid-conduits, such as the lubrication systems and fuel system, in a vehicle or in other types of motors.

The presence of the polysiloxane additive in the engine oil leads to the formation of a film on the surface of the engine parts.

Without being bound to particular theories, polysiloxanes can be converted to three types of surfaces that are formed during the coating process that alone or in combination lead to increased lubricity, prevent abrasion, seal the combustion chamber, etc. and are thermally resistant coatings that are either physically pliable or extremely hard.

1. Heating liquid polysiloxanes increases cross-linking resulting in polysiloxanes with increased molecular weight as shown in structure A below. Such polysiloxanes with increased molecular weights are solids at the temperatures of typical engines. Such a polymerization process can be facilitated by the metal surface acting as a catalyst. Such polymerization reactions are accelerated by higher temperatures and high pressures generated between metals parts in combustion engines can also facilitate the generation of strong antiwear films. Thus, the films could specifically form on the metal surfaces that are subjected to the highest temperatures and pressures where such films would be most beneficial. Such a material can exhibit temperatures in the ranges found in the combustion chamber and can act to provide a glass-coating that is deformable and that can readily form seals. 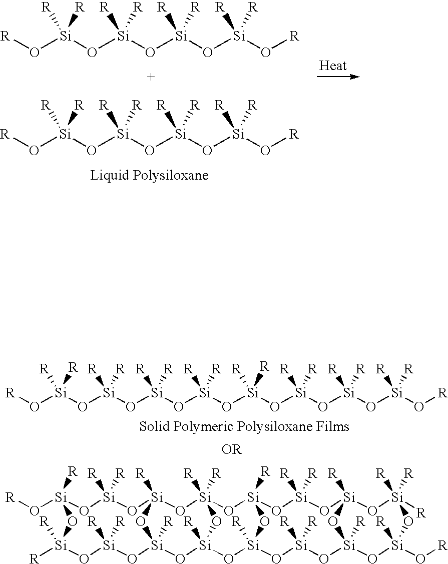
Structure A. Polymerization of Liquid Polysiloxane to Generate Solid Polysiloxane Films

2. In addition to the formation of films by polymerization and crosslinking as shown in Structure A, also harder ceramic films can be produced by decomposition or pyrolysis reactions of the polysiloxane additives as shown in Structure B that occur in the engine. As discussed above, it is also likely that such ceramic films would be most efficiently and beneficially generated on the metal surfaces that are hottest and under the most pressure. As shown, the most likely ceramic surfaces would be those resulting from formation of silica (SiO₂) or silicon-carbide-oxide (SiCₓO_{y}) coatings formed on pyrolysis of siloxane type. Significantly, in the presence of volatile precursors to these films growth around metal particles is facilitated. Under the conditions of a combustion chamber such ceramic film growth can occur on the surfaces of the combustion chamber, e.g. the rings, piston, etc. that are the hottest and under the most pressure leading to more efficient sealing and more efficient combustion. 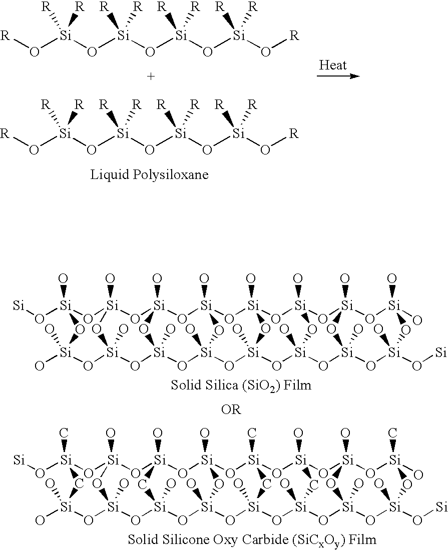
Structure B. Decomposition or Pyrolysis of Polysiloxanes to Silica (SiO₂) or Silicon Oxy Carbide Ceramic Films

The concentration of polysiloxane, in particular of polyether- or polyester-modified polydialkylsiloxane in the mixture with oil or fuel can be between 0.5 percent to 2.5 percent by volume (all concentrations expressed herein are by volume unless otherwise indicated) and, in particular embodiments, the concentration of the siloxane is between 0.5 to 1.5 percent. Any other percentages between 0.001% and 100% depending on the particular use are possible as well. If applied as an oil additive, the coating takes whatever it needs to form itself from the oil-polysiloxane mixture and leaves the rest in the oil. For this reason, there is basically no upper percentage, as long as sufficient lubrication of the engine is provided. Lower percentages that 0.5 are possible, but it has shown that already at 0.5% it takes a longer time to form the coating. It has to be understood that the percentage needed is also related to the engine surface to be coated, and has to increase also with the amount of deposits in the engine since the additive also performs some kind of a cleaning process. The Polyether- or polyester-modified polydialkylsiloxane can also be added directly to the engine oil in the oil pan of an automobile. However, the enhanced lubricating properties from use of the siloxane will not be realized until the siloxane is generally uniformly dispersed throughout the engine oil. Other ways of adding the polydialkylsiloxane are to mix it directly with the fuel, in particular in the case of a 2-stroke engine. Such a mixture would be preferably between 1:40-1:60 polysiloxane:fuel. It takes usually only one fuel tank to achieve the coating and the coating may last for 10,000 or more miles and then other oil can be used. Stronger coatings may be achieved by having the additive in several fuel tanks, or it is likewise possible to use the polysiloxane additive continuously as the regular oil, i.e. in every fuel tank filling. In this case, adding can be effected either by premixing the polydialkylsiloxane with the fuel, or by injecting it from a separate chamber into the combustion chamber. If injected directly, a dispersion or suspension in water has an additional cleansing effect. Since the water is evaporated and at least partially split into oxygen and hydrogen in the combustion chamber a further reduction of the C, CO and NOx emission is achieved. Other possible carriers/solvents are alcohol based or mineral based. Moreover, direct injection allows a high concentration of the polydialkylsiloxane dispersion or suspension up to the pure product, called a 100% product by a manufacturer named BYK Chemie USA, Inc. of Wallingford, Conn. One of the useful products is for instance labeled BYK-333.

To reduce the time it takes to uniformly disperse the polyether- or polyester-modified polydialkylsiloxane throughout the lubricant, the siloxane can be premixed with a quantity of the lubricant, such as motor oil, to produce a premixture having a concentration of approximately 8 to 33 percent siloxane, or in a more-specific embodiment, at a ratio of one part siloxane to five parts oil to form a siloxane-and-oil additive. The siloxane-and-oil additive is then added to the quantity or pool of lubricating oil in an oil pan or reservoir to obtain a siloxane concentration of, e.g., between approximately 0.5 to approximately 2.5 percent. Depending on the use, also other concentrations are possible.

In one embodiment, the polyether- or polyester-modified polydialkylsiloxane is mixed with oil to form the siloxane-and-oil additive using a sonic mixer, although other mixers including shear-producing mixers, such as a homogenizer or spray-nozzle-type mixer, can alternatively be utilized. The mixture is heated during mixing until the temperature of the mixture reaches approximately 200 degrees Fahrenheit (93° C.). The mixture is mixed for sufficient time until the siloxane is generally uniformly distributed throughout the oil forming a fine suspension or dispersion of the polyether-modified polydimethylsiloxane in the oil. It is believed that improved lubricating properties will be achieved with fine emulsion. In addition, any impurities that might be present in the oil or siloxane are filtered out, bringing the maximum impurity particle size down to less than 2 microns. The resulting dispersion is filtered through a filter with a pore size of approximately 2 microns to filter out impurities or siloxane, and the droplet size or agglomerates thereof exceeding 2 microns in diameter are reduced to smaller droplets, preferably 1 micron or lower to guarantee proper degrading of the polydialkylsiloxane as part of the coating process. Approximately 12 fluid ounces of the siloxane-and-oil additive or mixture, mixed in the manner described, is then added to enough oil to result in approximately five quarts of lubricant including the siloxane-and-oil additive which results, in this case, in a formulation of lubricant including approximately 1.25 percent-by-volume polyether- or polyester-modified polydialkylsiloxane. A typically recommended amount is 1 ounce on 5 quarts of lubricant for a normal motor. Older Motors with more internal deposits may require a higher amount, for instance 2-3 ounces on 5 quarts of lubricant.

Numerous advantages are offered by various methods and compositions, described in greater detail below. First, a lubricant composition including the polyether- or polyester-modified polydialkylsiloxane can offer filming properties that are substantially improved over those of existing motor oils that incorporate known additives and over existing synthetic lubricants. Moreover, these excellent filming properties can be maintained even at high temperatures and after the engine stops running. Consequently, the lubricant including the polyether- or polyester-modified polydialkylsiloxane, when used in an engine, can remain on engine parts longer after the engine stops running. Additionally, the small droplet size of the polyether- or polyester-modified polydialkylsiloxane enables it to be mixed with an oil in a fine emulsion without separation and without settling of the siloxane from the oil. Further, unlike, naturally occurring siloxanes, which may be formed in an engine as a byproduct of the combustion cycle and as a byproduct of infiltration of dirt into the engine. Inclusion of the polydialkylsiloxane in the motor oil also reduces harmful vibrations in the engine due to the removal of dissolved gases. Further still, inclusion of the polydialkylsiloxane increases the flashpoint of the motor oil, increases the service life of the motor oil, reduces pollutant emissions from the engine, and enables better sealing of the pistons in the engine by the motor oil. The polydialkylsiloxane also helps to reduce engine rust by substantially eliminating moisture from the motor oil.

Further still, when the polyether- or polyester-modified polydialkylsiloxane is included in a fuel, the polydialkylsiloxane can increase the pumping capacity of the fuel system by lubricating the pump and the lines of the injection system. The polydialkylsiloxane can also help to prevent vapor lock caused by vaporization in the fuel line.

### BRIEF DESCRIPTION OF THE DRAWINGS

FIG. 1 is a schematic diagram of a system and process for formulating a polyether- or polyester-modified polydialkylsiloxane-and-oil lubricating composition.

FIG. 2 shows a cylinder block of an engine treated with polydialkylsiloxane that was cut (sawed) in half through the centerline of the cylinder and crankshaft.

FIG. 3 shows a cylinder block of an engine as in FIG. 2, but on an untreated engine.

FIG. 4 is a diagram and table demonstrating the surface roughness in the non-combustion chamber zone of the treated engine denoted as section A in FIG. 2.

FIG. 5 is a diagram demonstrating the surface roughness of the treated engine in the combustion chamber zone denoted B in FIG. 2.

FIG. 6 is a diagram and table demonstrating the surface roughness in the non-combustion chamber zone of the untreated engine denoted as section A in FIG. 3.

FIG. 7 is a diagram demonstrating the surface roughness of the untreated engine in the combustion chamber zone denoted B in FIG. 3.

FIG. 8 (a) shows the borderline at the lower dead center between sections A and B for the treated engine shown in FIG. 2.

FIG. 8 (b) shows the equivalent borderline as in FIG. 8 (a) for the untreated engine shown in FIG. 3.

FIG. 9 (a) and 10 (a) show the piston ring in a treated engine.

FIG. 9 (b) and 10 (b) show the piston ring in an untreated engine.

FIG. 11 shows the rod caps embracing the crank shaft, denoted 1 in the treated and denoted 2 in the untreated engine.

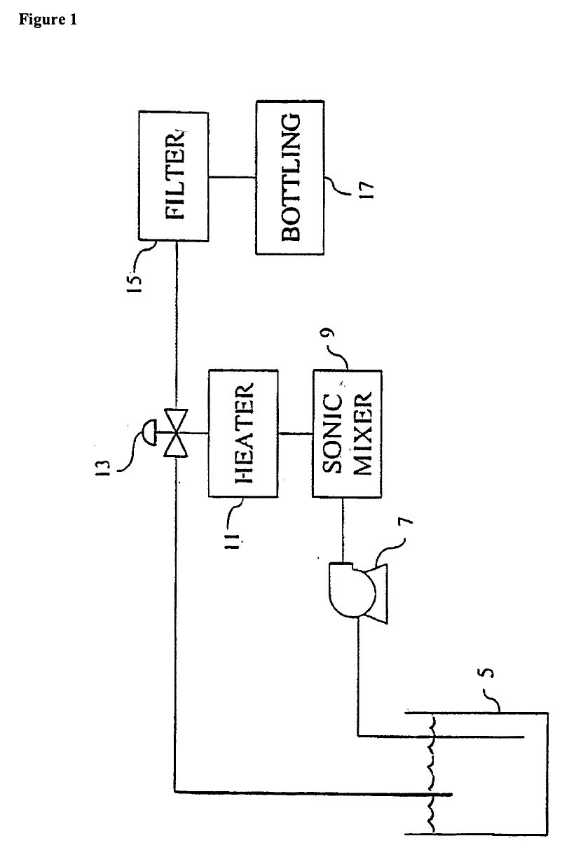

### DETAILED DESCRIPTION

Particular embodiments of the present invention are included in the following discussion; however, it is to be understood that the disclosed embodiments are merely exemplary of the invention, which may be embodied in various forms. Consequently, specific details disclosed herein are not to be interpreted as limiting, but merely serve as a basis for the claims and as a representative basis for teaching one skilled in the art to variously employ the present invention in a broad range of alternative formulations and processes.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Moreover, while this invention has been shown and described with references to particular embodiments thereof, those skilled in the art will understand that various other changes in form and details may be made therein without departing from the scope of the invention.

It has been discovered that a polyether- or polyester-modified polydialkylsiloxane, when added to a selected quantity of a lubricating oil produces a lubricant having improved filming properties, particularly at elevated temperatures.

In particular, the method of the invention for lubricating a vehicle comprises:
adding polyether- or polyester-modified polydialkylsiloxane to a fluid-conduit system in an engine-operated vehicle, wherein the polydialkylsiloxane forms a mixture with oil in the fluid-conduit system; and
operating the engine of the vehicle, wherein the mixture of polydialkylsiloxane and oil coats automobile parts accessed by the fluid-conduit system.

The polyether- or polyester-modified polydialkylsiloxanes of the present invention can generally be represented by the following chemical formula (1): 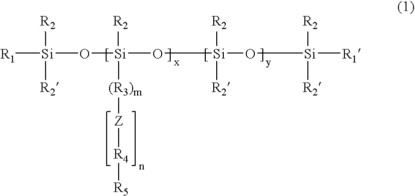
wherein
Z is independently selected from O, 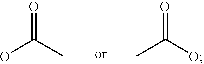
R₁ and R_{1′} are independently selected from C₁-C₆ alkyl and -Z-(C₁-C₆ alkyl)
R₂ and R_{2′} are independently selected from C₁-C₆ alkyl;
R₃ is —(C(R₆)(R₇))—;
R₄ is —(C(R₈)(R₉))ᵥ—;
R₅ is selected from hydrogen, —O—(C₁-C₆-alkyl) and C₁-C₆ alkyl;
R₆, R₇, R₈ and R₉ are independently selected from hydrogen and C₁-C₆ alkyl;
n is an integer from 1 to 10;
m is an integer from 0 to 5;
v is an integer from 1 to 4;
x is an integer from 1 to 150; and
y is an integer from 1 to 500.

In the above formula (1), the C₁-C₆ alkyl comprises methyl, ethyl, propyl, butyl, pentyl and isomers thereof. In a preferred embodiment the C₁-C₆ alkyl group comprises methyl, ethyl, propyl and isomers thereof. In one particular preferred embodiment of the present invention R₁, R_{1′}, R₂ and R_{2′} are methyl so as to form a polyether- or polyester modified polydimethylsiloxane. All C₁-C₆ alkyl groups can be optionally substituted, i.e. one or more of the hydrogen atoms of the alkyl groups can be replaced by a substituent selected from the group consisting of methyl, ethyl, propyl, —F and —Cl.

The polydialkylsiloxanes used in the present invention can be in a solid form or in a liquid form, all being indicated as particles, dependent on their molecular weight and the alkyl groups used in particular for R₁, R_{1′}, R₂ and R₂. If the polydialkylsiloxane is in a solid form, particles with a diameter of less than 2 microns, preferably less than 1 micron are generally used in the present invention. If the polydialkylsiloxane is in a liquid form, then the polydialkylsiloxane will be present in droplet form within the same size range as mentioned above.

The physical properties of the polydialkylsiloxane will further be influenced by the respective type of polyether- or polyester group used in the polymer. If liquid siloxanes will be applied, said siloxanes usually have a viscosity from about 50 cs to about 1000 cs, preferably from about 100 cs to about 800 cs.

In the above formula (1), n is an integer from 1 to 10, preferably from 1 to 5. m is an integer from 0 to 5, wherein m is preferably 1 or 2. v is an integer from 1 to 4, while x is an integer from 1 to 150, preferably from 5 to 120. Furthermore, y is an integer from 1 to 500, preferably from 10 to 350.

For example, suitable polyether- or polyester-modified polydialkylsiloxanes can be obtained from BYK-Chemie USA, Inc. of Wallingford, Conn. Polyether-modified polydialkylsiloxanes can be used with a wide variety of petroleum-based lubricants, synthetic lubricants, or even with water, to form improved lubricating mixtures thereof for a wide variety of applications. Other uses of a polyether- or polyester-modified polydialkylsiloxane in an automobile include its use as an additive for (1) manual and automatic transmission fluid; (2) power steering fluid; (3) gear oil for use in a differential; (4) all-purpose machine lubricant; and (5) any type of fuel (e.g., in standard grades of gasoline and in a two-cycle engine in lieu of petroleum-based lubricants or diesel fuel). Further still, the additive can be used as a rust and corrosion inhibitor and as a lubricant for plastic and rubber surfaces. Other useful mixtures can be with wd40, grease, water, or alcohol.

In one embodiment of the present invention, the polyether- or polyester modified polydialkylsiloxane is represented by the general formula (2): 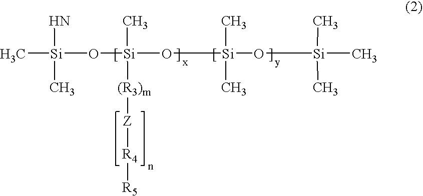
wherein
Z is independently selected from O, 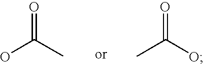
R₃ is —(C(R₆)(R₇))—;
R₄ is —(C(R₈)(R₉))ᵥ—;
R₅ is selected from hydrogen, —O—(C₁-C₆-alkyl) and C₁-C₆ alkyl;
R₆, R₇, R₈ and R₉ are independently selected from hydrogen and C₁-C₆ alkyl;
n is an integer from 1 to 10;
m is an integer from 0 to 5;
v is an integer from 1 to 4;
x is an integer from 1 to 150; and
y is an integer from 1 to 500.

In formula (2), C₁-C₆ alkyl is the same as defined above. In a further preferred embodiment of the present invention, Z is —O— in formula (2).

Polydialkylsiloxanes, in particular polydimethylsiloxane, are inert and non-poisonous.

Motor oil is one example of a lubricating oil as mentioned above, with which the polyether- or polyester-modified polydialkylsiloxane is mixed. Motor oil typically is either a processed crude oil (petroleum) composition or in the form of a “synthetic” motor oil. In either, the motor oil serves to lubricate engine components so that the components will pass across one another without significantly sacrificing power due to friction. When the engine is running, the motor oil creates a film between moving parts, wherein this film substantially reduces friction between the parts. By coating parts, due to said polydialkylsiloxane additive, the motor oil also protects the parts from wear and against corrosion caused by acids that can form in the oil as a result of oxidation, condensation and combustion by-products. Motor oil with the polydialkylsiloxane additive also helps to clean the engine by preventing formation of deposits that can compromise fuel efficiency and engine performance in addition to causing engine wear. In particular, any solid particle larger than about 5-20 microns in size can seriously damage an engine if introduced directly into the combustion chamber without a chance to disintegrate into smaller particles. The motor oil helps to hold any such particles in suspension until they can be removed by the oil filter. Further still, motor oil serves to transport heat that is generated by combustion or by friction away from engine components such as the crankshaft, camshaft, timing gears, pistons, main and connecting rod bearings.

Motor oil includes a base fluid, known as a “basestock,” and an additive package. The basestock generally forms the majority of the motor oil and can either be petroleum or synthetic. Examples of motor oils having petroleum basestocks include Chevron SUPREME motor oil, Pennzoil MULTIGRADE motor oil, Kendall GT-1 motor oil, Castrol GTX motor oil, Mobil DRIVE CLEAN motor oil and many others. Examples of motor oils having synthetic basestocks include Mobil 1 SUPERSYN motor oil, Castrol SYNTEC motor oil, Valvoline SYNPOWER motor oil, Pennzoil SYNTHETIC motor oil, Kendall GT-1 SYNTHETIC motor oil and many others.

Petroleum basestocks are a purified form of crude oil and have been used since the earliest motor oils were developed. Petroleum basestocks include paraffins (wax), sulfur, nitrogen, oxygen, water, salts and a number of metals. These contaminants are substantially (though not fully) removed from the basestock via a refining process via a procedure including many or all of the following steps. First, the crude oil is distilled to remove salt contaminants. The crude oil is then subject to partial vaporization; the components of the crude oil with the highest boiling points, except for asphaltic materials, are separated to form the petroleum basestock. The basestock is then subject to vacuum distillation to separate it according to molecular weights and, accordingly, by viscosity. Solvents are extracted from the basestock. Waxes are also removed from the basestock to improve the basestock's low-temperature fluidity, which is compromised by wax crystallization at low temperatures. Hydrofinishing can also be performed, whereby the basestock is passed through a catalyst bed (or via clay treatment) to remove components such as sulfur and nitrogen from the basestock, thereby improving its oxidation stability, thermal stability and its color. Finally, hydrotreating can also be performed, wherein the basestock is subject to extremely high temperature and pressure in the presence of a catalyst to convert remaining aromatic hydrocarbon contaminants into usable nonaromatic hydrocarbon molecules.

Synthetic basestocks are chemically engineered specifically to meet the lubrication needs of an engine. Synthetic basestocks are engineered from pure, substantially contaminant-free compounds. Synthetic basestocks have been widely used in automobiles since the 1970's. Synthetic basestocks typically are formed of one or more of the following: polyalphaolefins, diesters, and polyolesters. Polyalphaolefin basestocks are the most common and are also referred to as “synthesized hydrocarbons.” Polyalphaolefin basestocks include no wax, metals, sulfur or phosphorous and have a viscosity index around 150 and a pour point below about 40° F. (4° C.).

In addition to the basestock, motor oils typically include an additive package to improve a variety of desirable properties in the motor oil. The additives, however, usually only form a small percentage of the oil, with the basestock forming the vast majority. Additives that improve the viscosity characteristics of the motor oil include pour point depressants, which improve the flow of the basestock at low temperatures by absorbing into wax crystals and lowering their volume. Pour point depressants are routinely used in petroleum basestocks but are often not needed in synthetic basestocks. Other additives relating to viscosity are viscosity index improvers, which are polymers that expand with increasing temperature; at high temperatures, the expanding polymers can compensate for high-temperature “thinning” of the basestock to help to provide a more-consistent viscosity in the motor oil across a broad temperature range.

Other classes of additives help to maintain lubricant stability in terms of helping to prevent breakdown and viscosity loss in the oil over time. First, detergents and dispersants help to minimize and contain build up in the form of sludge and varnish in an oil. Detergents and dispersants are attracted to the sludge and varnish contaminants and serve to contain and suspend those particles so that they do not agglomerate to form a deposit. Anti-foaming agents are also included in the oil to control formation of air bubbles in the oil, which can otherwise form at room temperature, as a consequence of the detergents and dispersants. As anti-foaming agents, very minor amounts of the respective additive are necessary. Additionally, oxidation inhibitors are included to reduce the tendency of oils to oxidize; the oxidation inhibitors either destroy free radicals or react with peroxides in the oil. Further still, corrosion inhibitors are included; the corrosion inhibitors either neutralize acids that form in the oil or coat metal surfaces so that the surfaces do not contact the acids. Finally, anti-wear agents, such as zinc and phosphorus, can be included in the motor oil to coat metal surfaces with a protective barrier against physical wear.

One embodiment of a polyether- or polyester-modified polydialkylsiloxane additive for a lubricating oil is produced by mixing the selected polyether- or polyester-modified polydialkylsiloxane with the lubricating oil at a ratio of one part polyether- or polyester-modified polydialkylsiloxane to five parts lubricating oil (based on the volume) to form a pre-mixed siloxane-and-oil additive, wherein the polyether- or polyester-modified polydialkylsiloxane is uniformly distributed in the oil in the form of a dispersion or suspension. For example, 55 gallons of standard 10W-30 motor oil may be mixed with 11 gallons with the aforementioned commercial product BYK-333 of the suspended or dispersed polyether- or polyester-modified polydialkylsiloxane to form the siloxane-and-oil additive. In various embodiments of this pre-mixture, the concentration of polyether- or polyester-modified polydialkylsiloxane is about 8 to about 33 percent-by-volume, and the concentration of the lubricating oil is about 67 to about 92 percent-by-volume, i.e. the ratio is from about 1:2 to about 1:12. This pre-mixture is then blended with the actual motor oil so that the aforementioned ratio above 0.5% polydialkylsiloxane, preferabley between 0.5 and 2.5% polydialkylsiloxane in the motor oil is achieved. In 2-stroke engines, the pre-mixture is either blended with the fuel, preferably from a separate oil reservoir.

The siloxane and the oil can be mixed using a sonic mixer, such as a Branson 900-B mixer sold by Branson Ultrasonic Corp. (Danbury, Conn., USA). Where a sonic mixer is used, the mixing can be accomplished using a pump to circulate the polyether- or polyester-modified polydialkylsiloxane and lubricating oil through the sonic mixer for approximately three to four hours or until the temperature of the mixture reaches approximately 200 degrees Fahrenheit (93° C.) due to the mixing. Although the temperature of the mixture rises due to the sonic mixing process, the mixture can also be heated using an external heater or other heating means.

The mixing process reduces the polyether- or polyester-modified polydialkylsiloxane to a generally spherical-shaped droplet or particle form, wherein the diameter of the particles can be less than approximately two micrometers (microns) and in particular mixtures is less than one micron. As used herein, the term, “diameter,” is generally intended to include the corresponding widest dimension of particles or droplets that are not spherical, such as a generally cube-shaped particle or droplet. If in particulate form, the benefits produced by the siloxane-and-oil additive when added to the lubricating oil will be realized for additive mixtures in which the particle size of the polyether- or polyester-modified polydialkylsiloxane is reduced to as small as 0.002 microns, preferably 0.001 microns in diameter. Before adding the siloxane-and-oil additive or mixture to a selected quantity of the lubricating oil, the siloxane-and-oil additive is filtered through a filter having a pore size of approximately 2 microns to filter out any siloxane particles, droplets or agglomerates having a diameter of more than two microns. Further, filters having a pore size of approximately 1 micron or less can also be used.

The formulation process is shown schematically in the Figure. Selected quantities of the selected polyether- or polyester-modified polydialkylsiloxane and oil (e.g., 55 gallons oil and 11 gallons siloxane) are added to a container or reservoir 5. Pump 7 then pumps the siloxane and oil through sonic mixer 9 and, optionally, through heater 11 to three-way valve 13. Valve 13 can be set or positioned in a first or recirculating orientation to continuously direct the flow of siloxane and oil back to reservoir 5, where the flow is re-circulated through the sonic mixer 9 and optionally through heater 11. Once the desired degree of mixing is obtained, the valve 13 can be set or advanced to a second or filling orientation in which the siloxane and oil flows into the filtering station 15 and is allowed to drain by gravity through a filter 15 to a bottling station 17 where the mixture of siloxane and oil is bottled in selected quantities, such as 12 ounces.

The premixed siloxane-and-oil additive is then added to a sufficient quantity of lubricating oil to form a selected quantity of lubricant, such as the recommended amount of oil to be held in the lubricating system of an automobile engine, such that the resulting percentage of polyether- or polyester-modified polydialkylsiloxane in the resulting lubricant is approximately between 0.5 and 2.5 percent and, in a particular example, is approximately 1.25 percent of the total volume. For example, twelve ounces of the siloxane-and-oil additive, formed at a ratio of one part siloxane to five parts oil, as explained above, can be added to enough oil to result in five quarts of a lubricant mixture. The resulting mixture includes approximately two ounces of polyether- or polyester-modified polydialkylsiloxane in 160 ounces of lubricant, such that the volume of siloxane is 1.25 percent of the total volume. In an automobile engine, where the polydialkylsiloxane has been added to the lubrication system, the polydialkylsiloxane will generally be well mixed in the oil after the automobile is driven about 10 miles (16 km).

Without being bound to any particular theory it is believed that the superior effect of the polyether- or polyester-modified polydialkylsiloxane is due to several different properties of the siloxanes.

Furthermore, the polyether- or polyester-modified polydialkylsiloxane serves to de-gas the motor oil and to displace moisture from the motor oil. The polydialkylsiloxane also prevents re-introduction of dissolved gases and water into the motor oil. Without the polydialkylsiloxane, motor oil typically comprises 10 to 15% infiltrated air, which is dissolved in the oil. As the typical motor oil approaches hot engine parts, the temperature of the motor oil rises, which causes the dissolved gas to vaporize, thereby forming air bubbles in the motor oil. Those air bubbles then grow larger and larger as the oil approaches the hot engine parts and temperature increases. The air bubbles displace oil and produce turbulence in the flow of the oil around the engine parts, thereby compromising the ability of the motor oil to coat the engine parts and producing potentially destructive harmonic vibrations in the engine due to explosion of the gas bubbles. Specifically, the coating avoids foaming on the surface of the respective engine part being lubricated since it has direct contact at a high concentration with the oil. Preventing foaming means basically preventing gas bubbles on the lubricated surface and that prevents displacement of oil by bursting gas bubbles. Since the coating has a much higher concentration of heat activated or heat degraded polydialkylsiloxane as a known anti-foaming agent, this enhances the anti-foaming properties significantly to an extent that cannot be achieved by the additive in the oil itself in absence of a completed coating process. In particular, in the low concentrations conventional anti-foaming agents are used as an additive in prior art, no effective coating results. In absence of the coating, more bursting gas bubbles are present on the surfaces resulting in more displacement of oil. The consequence of more oil displacement is more metal-to-metal contact that results in the worst case in harmonics and therefore in even more direct metal-to-metal contact causing abrasion.

In this scenario, the polyether- or polyester-modified polydialkylsiloxane serves a function far beyond traditional uses of “anti-foamants” in motor oil, wherein an anti-foamant is used to remove large gas bubbles, formed, e.g., by detergents. Rather, the polyether- or polyester-modified polydialkylsiloxane removes substantially all of the dissolved gas (e.g., at least 99.9% removal) and water from the oil. By substantially eliminating this source of gas bubbles when the motor oil approaches its maximum operating temperature, the motor oil flows more fluidly and smoothly around hot parts and better coats those parts. The flashpoint and oxidation temperature of the motor oil can also be raised substantially by the addition of the polydialkylsiloxane. For example, the flashpoint of a PENNZOIL 10/30 motor oil was raised from 228° F. (109° C.) to greater then 500° F. (>260° C.) by adding the polydialkylsiloxane.

Further, in an engine, the improved flow of the oil and the substantial removal of gas bubbles from around the hot parts enables the oil to form a film around piston cylinders, thereby sealing the pistons properly and cooling the pistons to thereby help to prevent pre-ignition due to contact of the fuel with overheated pistons.

Further still, the polydialkylsiloxane displaces moisture from the motor oil. The presence of moisture (i.e., water) in the motor oil can cause lubricated cast-iron parts to rust. Rust generates acid, which can destroy the oil and bearings lubricated therewith. Accordingly, inclusion of the polydialkylsiloxane helps to promote longer oil life [e.g., an oil life of 12,500 miles (20,000 km) or more] and also to lengthen the life of engine parts by displacing water (and gases) from the oil. One reason for the improved filming properties and lengthened life of the oil is the displacement of air and water by polydialkylsiloxane from the oil, but also other phenomena may contribute.

Additional additives can be added to the siloxane-and-oil mixture to enhance properties of the mixture. Potential additional additives include rust inhibitors and anti-oxidants. Selected strippers or solvents such as mineral spirits or lacquer thinner can also be added to strip off any glazing on engine parts formed during previous operation of the engine before introduction of the siloxane-and-oil additive. The stripper or solvent would function to deglaze the affected engine parts and to then volatilize at elevated engine-operating temperatures. It is believed that the material deglazed from the engine parts by the stripper is then filtered out of the lubricant as it passes through the oil filter. Other additives that can be included in the siloxane-and-oil mixture include viscosity index improvers or dimethylsulfoxide at a concentration of approximately one tenth of one percent (0.1%) for use as a blending agent, sodium hydroxide (0.0001%) as a blending and binding agent, and glycerol to help maintain the siloxane in suspension.

The polyether- or polyester-modified polydialkylsiloxane can be added directly to a quantity of lubricant, such as the motor oil in an oil pan of an automobile, without premixing the siloxane with a portion of the lubricating oil to be used, while still achieving the enhanced lubricating properties. Additional engine operational time is needed, however, for the siloxane to become generally uniformly dispersed throughout the engine oil when the polyether- or polyester-modified polydialkylsiloxane is added directly to the automobile engine oil, thereby extending the operational time before the maximum benefits of enhanced lubrication occur.

Finally, the polyether- or polyester-modified polydialkylsiloxane can be used as an additive to a motor oil, wherein said polyether- or polyester-modified polydialkylsiloxane is represented by general formula (1) or (2) as mentioned above.

Regarding the temperatures, research has resulted in that a very good temperature for depositing the coating on the surface like the cylinder wall is 345-425 Fahrenheit, while degrading of the coating does not happen below 2000 Fahrenheit. Typical piston temperatures are 375-500 F, while typical cylinder wall temperatures of water cooled cylinder walls are 250-375 F. The temperatures in the combustion chamber typically range between 800 and 1200 F. So roughly any temperature between 300 and 2000 F is appropriate for coating, preferably below 800 F.

A surface test where a layer of the various surface areas was evaporated and run through a spectrometer proved a significant increase of the silicon in a layer that was one micron thick from the surface. In this test, the baseline was first determined, i.e. the silicon content of the alloy that is for instance around 7%. After treatment, the increase in the silicon content was at least 5%, i.e. the spectrum revealed a silicon content of 12% if the baseline was 5%.

### EXAMPLE 1

### Coating Tests

Various tests demonstrated the improved lubricating and emission-reducing properties of the siloxane-and-oil additive. In one test, the coating capability of lubricant including the polydialkylsiloxane-and-oil additive at approximately 1.25 percent of the total volume was compared to the coating capability of a mixture of SLICK 50 Advanced Formula Engine Treatment in 10W-30 motor oil and to the coating capability of MOBIL 1 SYNTHETIC motor oil. Oils that were used for mixing with the polydialkylsiloxane are Penzoil 10/30, Castroil 10/30, Napa Premium 10/30, Union 76 10/30, Castrol Semi Synthetic 10/30 and Castroil Full Synthetic 10/30, all by weight. Equal quantities of each lubricant were applied to a hot plate heated to 350 degrees Fahrenheit (177° C.) and angled downward at a 45-degree angle. The hot plate comprised a TEFLON-coated aluminum plate. Through visual inspection, it was observed that the SLICK 50 engine treatment in 10W-30 motor oil and the MOBIL 1 SYNTHETIC motor oil did not adhere to or coat the surface of the hot plate to any appreciable degree and essentially just ran off the hot plate.

The test was performed as follows: All the oils tested were tested without the added polydialkylsiloxane. The test was completed with standard oil and runoff was noted. All the test oils were then mixed with the polydialkylsiloxane mix and retested as before. The results showed marked improvement as to coating properties on the hot plate. An oxidation test was performed in the same manner, where as a spoon shaped receptacle was used to hold 2 cc's of oil above a heat source of 800° F. for 2 min. observation of the samples showed that regular oils oxidized and evaporated within 10 to 30 sec. The same test was performed with the same base oils with a proportional addition of siloxane. Observations showed a significant reduction in oxidation and evaporation of the mixture. In 90% of the tests there was no noticeable change of the sample being tested. The remaining 10% of the samples that were tested showed a change 2 min into the testing and was found to be a result of wax/paraffin separating from the mixture, although it should be noted that the remaining oil remained stable and did not oxidize.

In contrast, visual observation of the surface onto which the polydialkylsiloxane-and-oil additive was poured revealed formation of a lasting and even lubricant coating thereon. The test was repeated with similar results for hot-plate temperatures ranging from 250 to 500 degrees Fahrenheit (121-260° C.). The tests demonstrated that the siloxane-and-oil additive adheres to and coats hot surfaces to a greater degree than does the non-treated SLICK 50 treated motor oil or the MOBIL 1 synthetic, Napa premium 10/30, Penzoil 10/30 and 30 wt., Union 76 10/30 and 30 wt. oil. Napa premium 10/30 did show slight coating prior to being treated with siloxane, although with the siloxane added it showed a marked improvement in coating at temp.

### EXAMPLE 2

### Comparative Horsepower Tests

The improved lubricating properties of lubricants including the siloxane-and-oil additive were further demonstrated by comparing the horsepower generated by an automobile engine operating without the siloxane-and-oil additive added to the lubricant versus the horsepower generated by the same automobile engine with the siloxane-and-oil additive added to the engine lubricant. In each case, the horsepower generated by a 1998 Jeep GRAND CHEROKEE LAREDO automobile having a 4.0-liter, six-cylinder engine was measured using a Dynajet Model 248C Dynamometer.

In a first test, the horsepower of the Jeep GRAND CHEROKEE automobile was initially measured without the siloxane-and-oil additive added to the engine lubricant. The lubricant utilized in the engine lubricating system was 5 quarts of 10W-30 petroleum based motor oil. In the first test, the engine of the automobile was accelerated from 0 to 5200 RPM (revolutions per minute), and measurements were taken at increasing increments of 250 RPM. During the first test, the absolute barometric pressure was recorded as 29.92 in. Hg (about 100 kPa) with a vapor pressure of 0.61 in. Hg (about 2 kPa). The intake air temperature was measured at 86 degrees Fahrenheit (30° C.), and the gear ratio was recorded as 49 RPM/MPH. A Society of Automotive Engineers (SAE) correction factor of 1.01 was used to convert the measured horsepower to a corrected horsepower.

A second test was performed on the same automobile by adding 12 ounces of the siloxane-and-oil additive to the engine-lubricating oil. The ratio of siloxane to oil in the additive was 1 ounce siloxane to 11 ounces oil. Adding the twelve ounces of additive to the existing 5 quarts of oil in the automobile resulted in a concentration of siloxane in the lubricant of approximately 0.58%. The automobile was again accelerated from 0 to 5200 RPM with measurements again taken at increasing 250 RPM intervals. During the second test, the absolute barometric pressure was recorded as 29.92 in. Hg (about 100 kPa) with a vapor pressure of 0.61 in. Hg (about 2 kPa). The intake air temperature was measured at 88.8 degrees Fahrenheit (31.6° C.), and the gear ratio was recorded as 48 RPM/MPH. An SAE correction factor of 1.01 was used to convert the measured horsepower to a corrected horsepower.

The measured and corrected horsepower of the automobile operating with lubricant only versus with the siloxane-and-oil additive added to the lubricant at various engine speeds is provided, below, in Table 1.

TABLE 1

| | Measured | Corrected | Measured | Corrected |
|---|---|---|---|---|
| | horsepower | horsepower w/o | horsepower | horsepower |
| Engine | w/o siloxane | siloxane | w/siloxane | w/siloxane |
| RPM | additive | additive | additive | additive |
| 3250 | 109.0 | 109.7 | 136.8 | 138.2 |
| 3500 | 117.5 | 118.3 | 119.8 | 120.9 |
| 3750 | 124.5 | 125.3 | 124.6 | 125.9 |
| 4000 | 129.7 | 130.6 | 130.0 | 131.3 |
| 4250 | 133.9 | 134.8 | 138.3 | 139.6 |
| 4500 | 138.5 | 139.5 | 142.7 | 144.2 |
| 4750 | 139.0 | 139.9 | 139.9 | 141.2 |
| 5000 | 133.4 | 134.3 | 135.2 | 136.6 |
| Avg. | 125.4 | 126.3 | 133.4 | 134.7 |
| Max. | 139.0 | 139.9 | 142.7 | 144.2 |

In comparing the data in Table 1, it can be seen that the corrected horsepower increased by an average of 8.4 horsepower when the siloxane-and-oil additive was added to the engine lubricant compared with the corresponding tests performed without the additive. In addition, the maximum horsepower achieved in the tests using the siloxane-and-oil additive exceeded the maximum horsepower in the tests without the additive by 4.3 horsepower. The test measurements of increased horsepower resulting from use of the siloxane-and-oil additive supports the conclusion that use of the siloxane-and-oil additive provides better lubrication of the engine parts.

### EXAMPLE 3

### ASM Emission Tests

A comparison of the emissions of automobiles with and without the siloxane-and-oil additive added to the engine lubricant Penzoil 10/30 was preformed using the acceleration simulation mode (ASM) emission test for the State of California. The test results, below, provide the measured exhaust concentrations of hydrocarbons (HC), carbon monoxide (CO), and nitrogen oxide (NOₓ) gases, which are generally considered harmful. The data in the column entitled, “Concentration without additive,” comprise the results for a first test in which no additive was added to the engine lubricant (5 quarts of motor oil), and the data in the column entitled, “Concentration with additive,” comprises the results of a second test in which 12 ounces of the siloxane-and-oil additive (at a ratio of 2 ounces siloxane per 10 ounces oil) were added to the engine lubricant to result in an overall concentration of siloxane in the lubricant of approximately 1.16% by volume.

TABLE 2
Vehicle Model: GMC YUKON Year: 1996 Mileage: 133,321
(214,559 km)

| | Concentration | Concentration | |
|---|---|---|---|
| | without additive | with additive and | |
| | and engine speed | engine speed at | Reduction with |
| Emission type | at 2110 RPM | 2149 RPM | additive use |
| Hydrocarbon | 68 ppm | 3 ppm | 95.6% |
| Carbon Monoxide | 0.54% | 0.04% | 92.6% |
| NOₓ | 377 ppm | 107 ppm | 71.6% |

TABLE 3
Vehicle Model: BMW 325i Year: 1995 Mileage: 70,329
(113,184 km)

| | Concentration | Concentration | |
|---|---|---|---|
| | without additive | with additive and | |
| | and engine speed | engine speed at | Reduction with |
| Emission Type | at 1960 RPM | 1935 RPM | additive use |
| Hydrocarbon | 83 ppm | 35 ppm | 57.8% |
| Carbon Monoxide | 0.1% | 0.05% | 50% |
| NOₓ | 217 ppm | 131 ppm | 39.6% |

TABLE 4
Vehicle Model: Jeep Grand Cherokee Laredo Year: 2000
Mileage: 27,845 (44,812 km)

| | Concentration | Concentration | |
|---|---|---|---|
| | without additive | with additive and | |
| | and engine speed | engine speed at | Reduction with |
| Emission Type | at 1451 RPM | 1440 RPM | additive use |
| Hydrocarbon | 7 ppm | 0 ppm | 100% |
| Carbon Monoxide | 0.04% | 0.0% | 100% |
| NOₓ | 131 ppm | 68 ppm | 48.1% |

TABLE 5
Vehicle Model: Dodge CARAVAN Year: 1988 Mileage:
123,767 (199,184 km)

| | Concentration | Concentration | |
|---|---|---|---|
| | without additive | with additive and | |
| | and engine speed | engine speed at | Reduction with |
| Emission Type | at 1717 RPM | 1871 RPM | additive use |
| Hydrocarbon | 931 ppm | 82 ppm | 91.2% |
| Carbon Monoxide | 1.2% | 0.17% | 85.8% |
| NOₓ | 319 ppm | 370 ppm | −16.0% |

These test results demonstrate that use of the siloxane-and-oil additive significantly reduced the concentration of hydrocarbons and carbon monoxide in each case, and significantly reduced the NOₓ emissions in all but one of the applications. These results support the conclusion that use of the siloxane-and-oil additive improves engine efficiency (i.e., provides more-thorough combustion of the fuel in the engine), which thereby reduces emissions of hydrocarbons, carbon monoxide and NOₓ gases.

### EXAMPLE 4

### Siloxane Alone in Automobile Engine Lubrication System

In one test, the polyether-modified polydimethylsiloxane at a viscosity of approx 10/30 wt. was the sole lubricant utilized in an automobile engine lubricating system. The polyether-modified polydimethylsiloxane was processed in the same manner as the siloxane-and-oil mixture described above with reference to the Figure, except that no oil was added. More specifically, polyether-modified polydimethylsiloxane, without oil, was circulated by pump 7 through sonic mixer 9 until the particle or droplet size was reduced to approximately one micron in diameter and then passed through the filter 15 to remove any particles having a diameter exceeding the pore size of approximately two microns. Approximately five quarts of the processed polyether-modified polydimethylsiloxane was then added to the engine lubricating system of an automobile to replace the recommended five quarts of motor oil, which was previously drained from the lubricating system. The automobile using the siloxane as the only lubricant was then run for approximately two thousand miles without any adverse affects identified. This test showed improved fuel use as compared to regular oils. Data collected prior to and after adding siloxane 100% showed a 3 mile per gallon savings after adding siloxane.

### EXAMPLE 5

### Use of Siloxane and Gasoline Mixture in a Two-Cycle Engine

In another test, the polyether-modified polydimethylsiloxane, processed in the manner described in Example 4, above, was added to gasoline to replace the two-cycle engine oil normally included in an oil-and-gas mixture used with a two-cycle engine. The ratio of gasoline to polyether-modified polydimethylsiloxane was fifty to one, and no adverse engine effects were observed. Passing through of particulate (oil) through the engine was reduced if not completely eliminated. No oil residue was noted when using siloxane in place of regular 2 cycle oil as compared to regular 2 cycle oils that were observed to pass through the engine as unburned solids, causing detrimental environmental damage to both land and water, as well as killing any plant life that the solids came into contact with. When using polydialkylsiloxane as a 100% product or in aqueous dispersion, suspension or solution in place of oil this was not to be considered a problem as any of the base lubricant that passed through the engine is not harmful to nature or humans. The test was performed for approximately 200 hours and temperature readings taken on the engine using the mixture of gasoline and polyether-modified polydimethylsiloxane were lower than simultaneous temperature readings taken on another two-cycle engine using the recommended gasoline and oil mixture. The temperature readings were taken using a digital, infrared thermometer. The reduced-temperature readings indicate improved lubricating properties of the siloxane versus two-cycle engine oil.

The polyether-modified polydimethylsiloxane can be premixed with a quantity of two-cycle engine oil before adding the resulting lubricant to the gasoline at the recommended fuel-to-lubricant ratio. Alternatively, processed polyether-modified polydimethylsiloxane can be added to the gasoline separate from the two-cycle engine oil to achieve the desired fuel-to-lubricant ratio.

While certain formulations of the present invention have been illustrated and described herein, the invention is not limited to the specific formulations described and shown. For example, although polyether-modified polydimethylsiloxane is described primarily with reference to its use in forming an additive for motor oil, polyether-modified polydimethylsiloxane has also been formulated and tested as an additive for power steering fluid, transmission fluid or oil and gear grease. Testing on these various formulations all showed improvement in the lubricating properties of the formulations. Such testing has also been performed on water-based Lubricants as well as petroleum-based lubricants. In addition, testing was done on a wide range of weights of oil, from 5 to 120 weight oil

The tests included although were not limited to motor oils from 20 wt to 140 wt oils as well as 10/20, 10/30, 10/40, 20/50. Also, tests included bearing grease, power steering fluids, axle lubricants from 50 to 160 wt in range. The tests were preformed on spray lubricants WD-40, and alike. It was noted that in all testing the addition of siloxane improved the lubricating features of the products being tested. When added to WD-40 it was noted that the lubrication features of this product was marked when tests of a mixture of siloxane and water were preformed and tested head to head with WD-40 spray lube. Test included lubricity, staining, water resistance, longevity.

It was noted that the use of WD-40 applied to test hinge mounted to metal door plate. WD-40 applied as directions required, coated the hinge with an oily coating that reduced sqeaking. Further, the use of this product caused permanent staining on the metal plate. When flushed with water (with water hose) the product repelled the water and staining remained. The test repeated with a 25% siloxane mixed with 75% water by vol. revealed that the siloxane mixture also coated the hinge and metal although the water evaporated and no noticeable staining occurred. After the mixture was dry and water was applied the lubrication of the mixture continued.

During all testing there was a marked improvement with each and every test and base lubricant used, so the addition of siloxane when mixed and used without the addition of a base lubricant worked equally across the tests performed.

### EXAMPLE 6

### Use of Siloxane in the Crank Case Oil of the Motor of an Airplane Piper Cherokee 140 (PA-28 140)

One-Year Test Results
Test Engine: LYCOMING MDL#0-320-E2A
Horsepower: 150

The test was performed on a piper Cherokee 140 (PA-28-140) airplane. The plane was purchased on Dec. 1, 2003 in Dallas, Tex. At the time of purchase, the engine logs reflected 1,850 hours of engine operation since its last engine rebuild/service (Factory recommends rebuild at 2,000 hour intervals). Upon inspection of the plane, the plane/engine showed signs of oil being bypassed from the engine crank case (blow by) and dumped out under the plane, leaving severe oil coating under the belly of the plane. The plane was then flown to California and took 15 hours. During this flight, all vital stats were watched closely. The following items were recorded during the flight; Oil consumption, fuel consumption per hour, engine performance, and head temperatures.

Flight Data:

Performance: Noted as (POOR) climb out 500 ft per min. Max. at 80 knots
Oil consumption=15 quarts per 5 hours engine time at cruise speed (60% power)
Fuel consumption=15-17 gallons per hour
Engine head temperatures at 10,000 ft at 60% power=190-240 degrees F.
Log book reflects last compression check to be #1 cylinder=74/80, #2 cylinder=72/80, #3 cylinder=70/80, #4 cylinder=72/80 (Compression Test Data based on a differential leak down test as prescribed by the manufacturer)

Upon returning to California, the plane was serviced and received an oil change. The oil that was drained from the engine had been in service for over 15 hours. The drained oil appeared very dirty and extremely dark (this oil had also been mixed with new oil from the trip back—over 30 plus quarts). Upon inspection of the filter media it was found to contain an unacceptable amount of metal deposits, indicating excessive bearing wear.

New oil (Aero Shell 100 wt) was added, the filter replaced, and 1 oz of polydialkylsiloxane was added to the crankcase. The engine was operated for ten hours and another oil change/filter replacement was performed. This oil change was to help flush out any contaminants/debris that was still present from the first oil change. New oil (Aero Shell 100 wt) was added, the filter replaced, and another 1 oz of polydialkylsiloxane was added to the crankcase.

The plane was operated in normal flight conditions for approximately 12-15 hours of service. At this time, a visual inspection of oil showed very little oxidation. Fuel burn was noted and reflected an hourly burn of 5.5 gallons per hour (with in the pattern and during level flight at 60% power). Oil consumption had been reduced to almost nothing and no additional oil was required after 15 hours of service.

Post: Polydialkylsiloxane Data

Performance: Very good for age, Normal climb out 800 ft.+ per min. 84 knots, No flaps
MAX=(Normal day, pilot and 350 lb's Fuel, 1700 ft. min. Max at 64 knots, 10 deg. Flaps)
Oil consumption=1 qt per 25-30 hours of service (cruise speed/60% power or better)
Fuel consumption=5.5-6.4 gallons per hour
Engine head temperatures at 10,000 feet at 60% power=140-160 degrees F.
   180 degree F. noted on climb out of 800 ft per minute to a ceiling of 10,000 ft.

Compression check 1-year later (with no Mechanical repairs noted) was the following; #1 cylinder=78/80, #2 cylinder=78/80, #3 cylinder=78/80, #4 cylinder=78/80 (Compression Test Data based on a differential leak down test as prescribed by the manufacturer)

Test above (Post polydialkylsiloxane) was performed at the airplanes annual inspection. All tests were performed by a licensed FAA certified mechanic. The compression test showed a reading better than any log entry since and including when engine was new. At the time of the test, the engine had 2,430 hours of service since its last rebuild (430 hours more than recommended by factory). The mechanic noted that the engine was functioning at or above the planes factory specifications.

The conclusion of this airplane test over a period of approximately one year is that the addition of polydialkylsiloxane into the engine of this plane showed marked improvement in performance, significant reduction in oil consumption, increases in horse power that allowed the plane to climb at increased rates of 30-45% over factory rated specifications for this specific airplane. It should be noted that the engine, after polydialkylsiloxane treatment, also showed reduction in vibration, harmonics, engine noise levels, and demonstrated smoother accelerations.

### EXAMPLE 7

### Diesel Truck Smoke Test—“Opacity”

DIESEL TRUCK SMOKE TEST - OPACITY

| | |
|---|---|
| J.L. John Services, | Meter Mfg: Red Mountain |
| Inc. | Engineering, Inc. |
| Year and Make: | S/N: 8500240 |
| 1992 | |
| Year of Engine: | Model # Smoke Check 1667 |
| 1992 | |
| Engine Mfg: | Software Version: 3.69C |
| COUMM | |
| Engine HP: 350 | Vehicle Inspection OK |

BASELINE TESTED AFTER SILOXANE

| | TEST | ADDITION - 3 minutes | % DECREASE |
|---|---|---|---|
| Date | Jul. 08, 2004 | Jul. 08, 2004 | |
| Ambient Temp | 79.5 F. | 85.3 F. | |
| Baro. Press: | 29.39 inHg | 29.31 inHg | |
| Rel. Humidity: | 35.9% | 27.2% | |
| Mileage: | 512,854 | 513,239 | |
| Test 1: | 7.02 | 6.48 | −8.33% |
| Test 2: | 6.96 | 6.04 | −15.23% |
| Test 3: | 6.86 | 5.78 | −18.69% |
| Average of all | 6.95 | 6.10 | −13.88% |
| Tests: | | | |

| | TESTED AFTER DRIVING | |
|---|---|---|
| | 15 MILES WITH SILOXANE | % DECREASE |
| Date | Jul. 08, 2004 | |
| Ambient Temp | 86.4 F. | |
| Baro. Press: | 29.31 inHg | |
| Rel. Humidity: | 25.4% | |
| Mileage: | 513,254 | |
| Test 1: | 4.12 | −70.39% |
| Test 2: | 4.34 | −60.37% |
| Test 3: | 4.67 | −46.90% |
| Average of all | 4.38 | −58.72% |
| Tests: | | |
| | TESTED AFTER DRIVING | |
| | 100 MILES WITH | |
| | SILOXANE | % DECREASE |
| Date | Jul. 29, 2004 | |
| Ambient Temp | 75.9 F. | |
| Baro. Press: | 29.5 inHg | |
| Rel. Humidity: | 5160.0% | |
| Mileage: | 513,354 | |
| Test 1: | 0.00 | −100.00% |
| Test 2: | 0.00 | −100.00% |
| Test 3: | 0.00 | −100.00% |
| Average of all | 0.00 | −100.00% |
| Tests: | | |

Test Description:

This test is currently being used for measurement of particulate in diesel trucks stack exhaust in to California. The testing equipment is portable and fairly easy to operate. The equipment consists of a telescopic pole (9-12 ft) with one end consisting of a triangular shaped apparatus that houses a laser/optical measurement device. The measuring device is attached to a hand-held computer and a recording/printing mechanism. A bung protruding from the measurement device is placed directly into the exhaust stack allowing the triangular housing to rest above/across the exhaust pipe opening. The measurement device measures smoke/exhaust across two points using laser light refraction. The truck is in idle and the first measurements are calculated. The tester, in the cab of the truck, steps on the accelerator and holds it down at set RPM's for a set period (approx. 5 seconds). This test is repeated and measured several times as the handheld computer instructs the tester along the way. These measurements are recorded and calculated in a report. This calculates the particulate/opacity of the diesel exhaust under load.

The chart that follows includes all of the testing data recorded during four different tests. The first test is the baseline and is used to calculate all of the comparisons among the other tests after being treated with polydialkylsiloxane (in the oil crankcase). The three tests were run at different times based on mileage after polydialkylsiloxane addition to the system.
1. 3 minutes after idling with addition of Polysiloxane
2. After driving 15 miles with addition of Polysiloxane
3. After driving 100 miles with addition of Polysiloxane

Looking through the data presented on the chart, it is evident that the effects of polydialkylsiloxane addition can be seen fairly quickly. In the first test, as much as 18.69% reduction of particulate/opacity can be measured after only 3 minutes of being added.

As the engine is put under load and driven over the next 15 miles, the results become even more dramatic. After 15 miles under load, as much as 70.39% reduction of particulate/opacity was realized.

The third test, after driving the truck for 100 miles, the test results are even better. Between tests, the measuring device was used on two other trucks and calibrated to insure the readings of the device. The readings indicated that after 100 miles, 100% removal of the diesel exhaust particulate had been achieved.

### EXAMPLE 8

### Testing the Waste Gas Emissions of a Jeep Cherokee Under Different Driving Conditions Under CFR-40 Part 86 of the Federal Rest Guide

The following is a brief description of the test procedure and the basic process involved. For exact procedures please reference the Federal Test Guide—CFR-40 Part 86. The Environmental Protection Agency uses this test to analyze and measure emissions from gas fueled motor vehicles. The CVS/FTP tests consists of three phases that are modeled after normal on-road vehicle usage. This includes the vehicle to perform: a cold start (minimum 12 hours of no operation of the vehicle engine), starts and stops (similar to vehicle operations when approaching a stop sign, braking until reaching a full stop, and accelerating from a stopped position), hills (accent of 10%+ grades), city driving (accelerating, braking, coasting, and complete stops), and highway driving (accelerating, maintaining speeds of 55+ miles per hour for set periods of time, coasting, acceleration similar to passing at speeds above 45+ miles per hour). Samples of the emissions are collected in bags and analyzed for THC, CO, NOx, CO2, and fuel economy. All personnel, tests, testing equipment, and testing facilities used for these tests are both EPA and California Air Resource Board (CARB) certified. A third party, California Environmental Engineering that has no affiliation or business relationship with the company or supplier of the oil catalyst, has conducted these tests.

Test Review

Drain existing fuel in test vehicle
Fill tank to 40% with specified test fuel (Indolene)
RunPrep cycle
12-hour controlled soak
Run CVS/FTP test for baseline (1)
Run second Prep cycle
12-hour controlled soak
Run second CVS/FTP test for baseline (2)
Make sure the two baselines are repeatable within a 10% tolerance
Add liquid oil catalyst
Drive 100 miles using AMA-Route
Reconstitute test fuel to 40%
Run Prep cycle
12-hour controlled soak
Run CVS/FTP test with oil catalyst (1)
Run Prep cycle
12-hour controlled soak
Run CVS/FTP test with oil catalyst (2)
Compare average of baseline results without catalyst to average of results using liquid oil catalyst.
   Test Summary
4 Preps
4 CVS/FTP with Bags
   Test Vehicle
1988 Jeep Cherokee
V.I.N.—1JCMU77448JT07959
   Test Facility
California Environmental Engineering
2530 South Birch Street
Santa Ana, Calif. 92707
   Test Results

The test results for the following vehicle were extremely positive in regards to reduction of tailpipe emissions. After treating the vehicle with the oil catalyst, test results indicate reductions across the board. The reductions and end results for this vehicle are as follows:
Total Hydrocarbons (THC)—reduction of 72.84%
   Measured as grams/mile (gr/m)
Carbon Monoxide (CO)—reduction of 92.95%
   Measured as grams/mile (gr/m)
NOX (NOx)—reduction of 26.53%
   Measured as grams/mile (gr/m)
Fuel Economy—increase of 3.81%
   Measured as miles per gallon (mpg)

These results indicate that by using the oil catalyst in the oil crankcase of gasoline powered vehicles; significant reductions in emissions can be achieved. These tests results are very similar to test results done on over 50 vehicles using the California State Smog Test (Smog Check Vehicle Inspection/ASM Emission Test) used for vehicle inspection, certification, and registration. In these tests, vehicles were tested for emissions at set speeds of 15 mph and 25 mph. At each speed, readings are taken for % CO2, % O2, Hydrocarbons (HC)—measured by parts per million (PPM), CO (%), and NOx (NO)—measured by PPM. From the tests performed at CEE, we can conclude that there is some sort of lineal relationship between the two tests and the data collected. The CVS/FPT tests is cumulative and measures the data as grams per mile vs. the ASM Emission Test that collects data based on two specific speeds (15 mph, 25 mph)/engine loads and measures the data as a % and as PPM. The reductions in the CVS/FPT tests indicate similar % reductions as the ASM Emission tests in the studies done prior to this test. Both tests show that vehicles tested after introduction of the oil catalyst are achieving major reductions in vehicle emissions. At this point in testing and comparative analysis, it is clear that when the ASM Emission test is positive (reducing emission % and PPM), the CVS/FPT are also consistently positive (reducing emission % as grams per mile). Further testing will have to be performed to determine the specific mathematical lineal relationship between the two tests. This will be important for future testing and comparisons of future data.

It is also very important to note that savings can be achieved in the area of fuel economy. The EPA and CARB believe that any fuel savings or increases above 2.5% (mpg) are significant and are worthy of further investigation and analysis. The test results for fuel economy show increases of 3.81% (mpg) after the introduction of the oil catalyst vs. fuel economy of the vehicle without the catalyst. This is a very positive finding and should lead to opportunities in business's that utilize “fleets of vehicles” such as governments, military, or municipalities. The impact could also be important for personal vehicle usage, especially with the rising costs of fuels worldwide.

### EXAMPLE 9

### Testing the Waste Gas Emissions of a Mercedes Benz Turbo Diesel Under Different Driving Conditions Under CFR-40 Part 86-EPA 78 of the Federal Rest Guide

The following is a brief description of the test procedure and the basic process involved. For exact procedures please reference the Federal Test Guide—CFR-40 Part 86-EPA 78. The Environmental Protection Agency uses this test to analyze and measure emissions from diesel fueled motor vehicles. The CVS/FTP tests consist of three phases that are modeled after normal on-road vehicle usage. This includes the vehicle to perform: a cold start (minimum 12 hours of no operation of the vehicle engine), starts and stops (similar to vehicle operations when approaching a stop sign, braking until reaching a full stop, and accelerating from a stopped position), hills (accent of 10%+ grades), city driving (accelerating, braking, coasting, and complete stops), and highway driving (accelerating, maintaining speeds of 55+ miles per hour for set periods of time, coasting, acceleration similar to passing at speeds above 45+ miles per hour). Samples of the emissions are collected in bags and analyzed for THC, CO, NOx, CO2, Particulate Matter (PM) and fuel economy. All personnel, tests, testing equipment, and testing facilities used for these tests are both EPA and California Air Resource Board (CARB) certified. A third party, California Environmental Engineering that has no affiliation or business relationship with the company or supplier of the oil catalyst, has conducted these tests.

Test Review

Drain existing fuel in test vehicle
Fill tank to 40% with specified test fuel (test diesel)
Run Prep cycle
12-hour controlled soak
Run CVS/FTP test for baseline (1)
Run second Prep cycle
12-hour controlled soak
Run second CVS/FTP test for baseline (2)
Run third Prep cycle
12-hour controlled soak
Run third CVS/FTP test for baseline (3)
Make sure the three baselines are repeatable within a 10% tolerance
Add liquid oil catalyst
Drive 100 miles using AMA-Route
Reconstitute test fuel to 40%
Run Prep cycle
12-hour controlled soak
Run CVS/FTP test with oil catalyst (1)
Run Prep cycle
12-hour controlled soak
Run CVS/FTP test with oil catalyst (2)
Compare average of baseline results without catalyst to average of results using liquid oil catalyst.
   Test Summary
6 Preps
6 CVS/FTP with Bags
   Test Vehicle
1984 Mercedes Benz Turbo Diesel
V.I.N.—#WDBAB33A8EA178601
   Test Facility
California Environmental Engineering
2530 South Birch Street
Santa Ana, Calif. 92707
   Test Results

The test results for the following vehicle were extremely positive in regards to reduction of particulate matter and tailpipe emissions. After treating the vehicle with the oil catalyst, test results indicate reductions across the board. The reductions and end results for this vehicle are as follows:
Total Hydrocarbons (HHC)—reduction of 10.6%
   Measured as grams/mile (gr/m)
Carbon Monoxide (CO)—reduction of 4.9%
   Measured as grams/mile (gr/m)
NOX (NOx)—reduction of 2.3%
   Measured as grams/mile (gr/m)
Fuel Economy—increase of 1.1%
   Measured as miles per gallon (mpg)
Particulate Matter (PM)—reduction of 18.1%
   Measured as grams

These results indicate that by using the oil catalyst in the oil crankcase of diesel powered vehicles; significant reductions in particulate matter and emissions can be achieved.

### EXAMPLE 10

### Diesel Fuel Efficiency Protocol from the Canadian Hydrogen Energy Company Ltd.

Fuel Efficiency Protocol Objective:

1. To establish a Trip Data “Base Line” which is conducted, under controlled conditions on a specific vehicle (Cab or Cab and Trailer). All pertinent data must be accurately detailed and recorded. Base Line data collection to be performed with HFI Unit “OFF”.
2. Perform Trip Collection Session(s) with HFI Unit “ON”(polysiloxane added).
3. Each subsequent Trip Collection Session will have selective parameter(s) (varied by design) for comparative purposes.
4. The Base Line Data Point will then be compared to all other Trip Data Collection Sessions (where appropriate).
5. Data variable variations must be kept to minimum as analysis/conclusions may be affected.
   Data Collection:

A Base Trip Data Collection Point and 1 Trip Collection Sessions have been recorded using a CAT 430. Data Collection sessions occurred on Jun. 3, 2005.
1. Select a start-return route of 100 to 200 miles.
   Base Trip Data Collection
2. Ensure the vehicle (Cab only or Cab and Trailer) is readied for the trip.
   Check/correct/record tire pressure
   Fill fuel tank(s) to maximum and record fuel data
   Weigh vehicle and driver at certified scale at same location as fuel fill location, e.g. Fifth Wheel
   Record atmospheric temperature
   Record prevailing wind data
   Ready to begin trip “first leg”
   Record odometer reading
   Ensure HFI unit is OFF
   Record time of trip “START”
   Ensure “constant speed”
   Reach half-way point and begin return portion
   Arrive to start location
   Record time
   Record odometer reading
   Weigh vehicle and driver at same certified scale
   Transfer data to Analysis Spreadsheet
   Base Data Collection Completed
      Trip Data Collection
3. Ready to collect Trip Data with Polysiloxane Added and to Compare Base Data
Ensure that minimum of 1 hour cool down
Ensure that the maximum amounts of variables are the same as for Base Data (temp, wind, driver, weight, tire pressure, etc.)
Fuel tank(s) should be filled to maximum (verify)
Weigh vehicle at same certified scale
Start trip, record time
Match base driving speed(s), etc. as per Base Collection Trip
Return to start and record al data

Variables to be Kept Constant on Each Trip as Compared to Base Trip:

| | |
|---|---|
| Driver | Same |
| Vehicle | Same |
| Tire pressure | |
| Weight | |

Driving Conditions

| | |
|---|---|
| Speed | Same |
| Cruise | Same |
| Lane selection | Same |
| Stop | Same |
| Start, etc. | Same |

Atmospheric Conditions

| | |
|---|---|
| Temperature | Same |
| Prevailing winds | Same |

Note:
1. Distance and Time of Trips should be within 0.5%
2. Variable variations between Base Data and other trip data collection sessions may affect analysis conclusions
3. All data to be recorded in appropriately bound Log Book
   Conclusion from Test Result:

The test conducted by Canadian Hydrogen Energy Company Ltd. is an on-the-road test that simulates normal highway driving conditions experienced by most truck driving fleets across the United States and Canada. The “Real World” test enables accurate recording of: fuel consumption, mileage, weight, weather conditions, tire pressure, driver factor, and a predetermined route.

The use of the Polysiloxane provided some excellent results in fuel economy. The end results calculated to 12.15% in fuel economy. These results indicate that the Polysiloxane has an immediate effect to the combustion chamber, providing better compression in the engine and increasing the efficiency in the fuel ignition system.

### EXAMPLE 11

### Comparative Test of an Engine Run with and Without Polydialkylsiloxane and Cutting Both Engines Apart

In order to evaluate the oil additive 2 separate engines were used. One to run without the additive and the other to run with the additive in the crankcase oil.

The engines used were Briggs and Stratton 3.5 hp single cylinder engines comparable to the engines found on individual home lawnmowers with:
Aluminum engine block and bore,
Aluminum rod caps and pistons,
Steel rings and crankshaft.

Both engines were run simultaneously for a period of 10 (ten) hours total. 2 hours at idle for break-in, and 7+ hours at maximum RPM. The unspecified time was checking harmonics of the engines in the mid-range RPMs.

At the end of the 10 (ten) hours, the engines were stopped, let cool and were disassembled and the components of each identified with a number “1” or “2” etched in the material specifying from which engine they were disassembled.

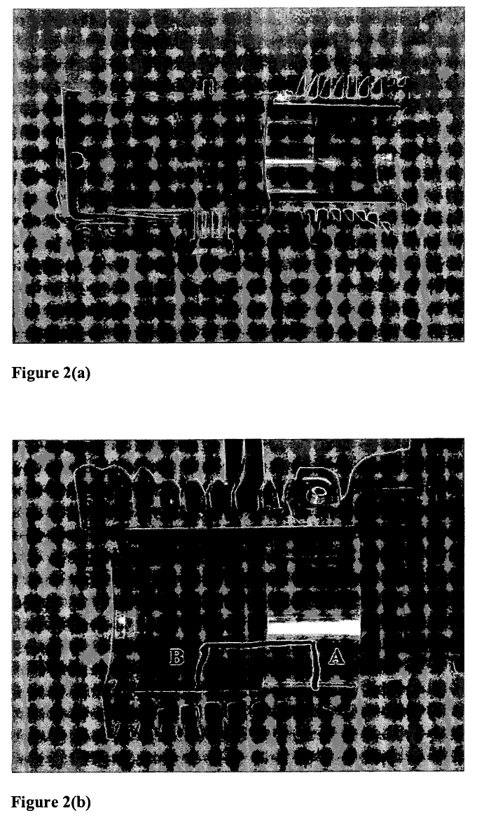

The cylinder blocks were also identified then cut (sawed) in half through the centerline of the cylinder and crankshaft. The cylinder block of the treated engine is shown in FIG. 2. As indicated therein, there are two regions, namely a region A beyond the piston ring travel zone, and a region B where the piston ring travels along the cylinder wall. In other words, zone B is basically the combustion chamber zone, and the border line between zones A and B is the bottom dead center for the piston ring. Zones A and B are two different zones in one and the same cylinder bore. Therefore, before the engine is operated for the first time, the surface roughness is the same in zones A and B. After use of the engine, the difference in surface roughness between zones A and zone B is caused by the contact of the piston ring with the cylinder wall grinding the cylinder wall. In the treated engine, the difference in surface roughness is partially caused by the grinding effect, partially by the coating process in the treated engine shown in FIG. 2.

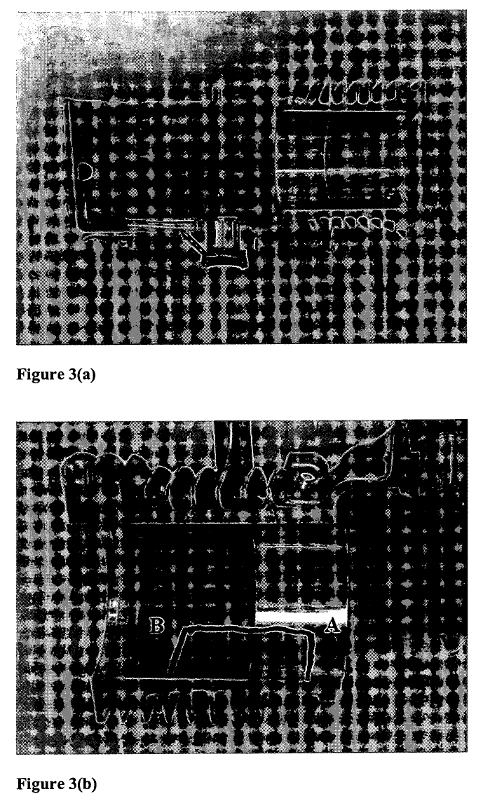

FIG. 3 shows the equivalent of FIG. 2, but for the untreated engine, i.e. the engine that was running without the polydialkylsiloxane.

Non-destructive dimensional tests were performed on the halves of the cylinder blocks. These tests consist of a profilometer reading of surface roughness on the contact and non-contact areas of both cylinder bores and a diameter reading on the same surfaces. The results were as follows:

| | TREATED ENGINE | | UN-TREATED ENGINE | |
|---|---|---|---|---|
| SURFACE | .5 | micron | 1.0 | micron |
| ROUGHNESS avg. | | | | |
| PEAK | 3.5 | micron | 4.5 | micron |
| ROUGHNESS after | | | | |
| PEAK | 21.5 | micron | 10.0 | micron |
| ROUGHNESS before | | | | |
| DIAMETER after | 2.5620 | inches | 2.5620 | inches |
| DIAMETER before | 2.5618 | inches | 2.5618 | inches |

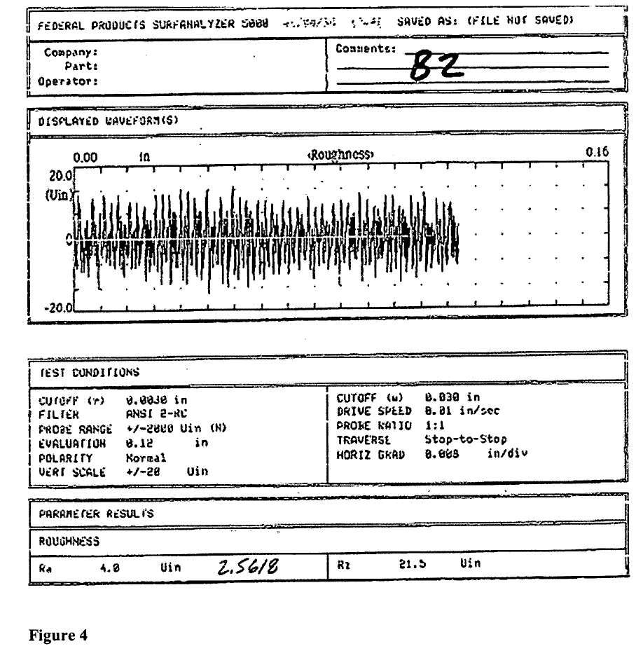

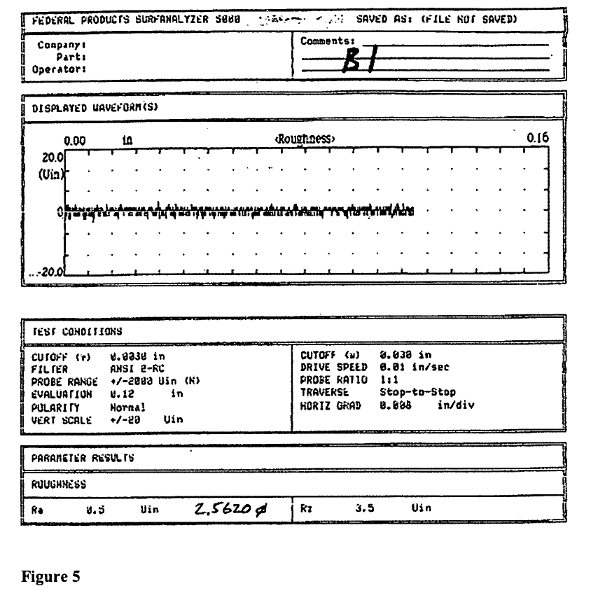

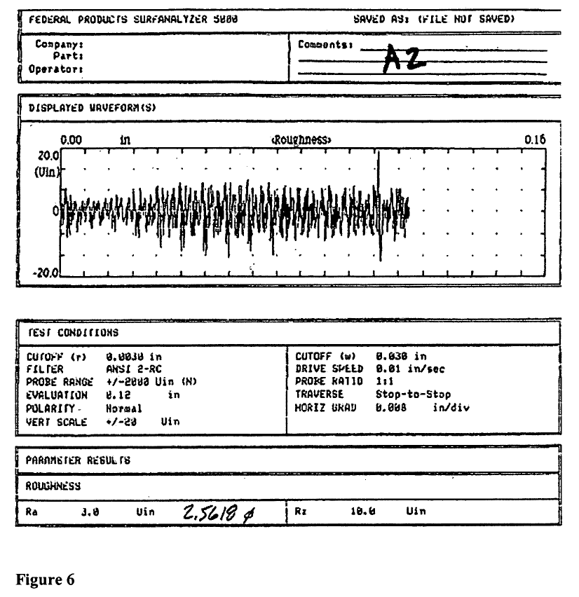

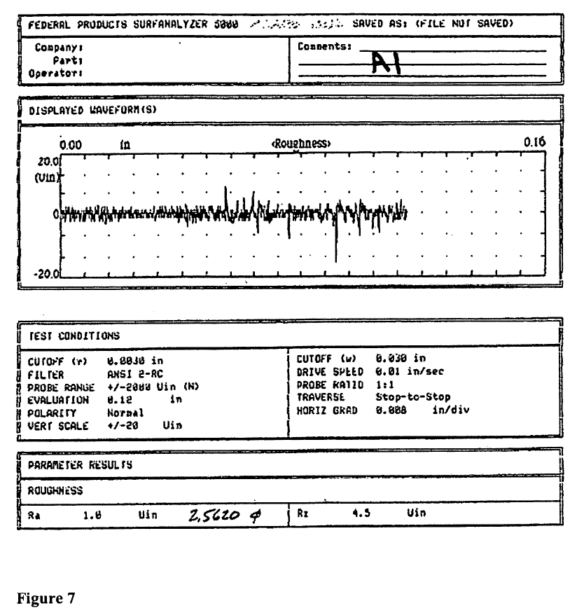

The results can be gathered from FIG. 4-7. FIG. 4 demonstrating the surface roughness in the non-combustion chamber zone of the treated engine denoted as section A in FIG. 2 while FIG. 5 shows the surface roughness of the treated engine in the combustion chamber zone denoted B in FIG. 2. The average roughness in the treated engine went down from 4.0 microns to 0.5 microns, while the peak roughness went down from 21.5 microns to 3.5 microns. The equivalent graphs are shown in FIGS. 6 and 7 for the untreated engine. Also here the surface roughness of the cylinder wall decreases through contact of the piston ring with the cylinder wall, but by far not as significantly as for the treated engine, namely in peak roughness only from 10.0 to 4.5 microns, and in average roughness from 3.0 to 1.0. Put in relation, the surface roughness decreased 6 times in peak and 8 time in average on the treated engine but only about 2 time in peak and 3 times in average on the untreated engine. This significant difference demonstrates that a significant coating takes place by adding polyether- or polyester-modified polydialkylsiloxane into the motor oil. Again, the ratio of the polydialkylsiloxane to motor oil is preferably between 0.5 and 2.5% for a regular 4-stroke engine, and if added to diesel fuel in a diesel engine in the same range, preferably a little lower like 1.5%. in a ratio of about 0.5 to 2.5% and in case of a two-stroke engine in a ratio of about 1% polydialkylsiloxane by volume to fuel.

Further tests revealed that once the coating has been completed, it lasts for about 15.000 miles without needing refreshment.

As a summary, both the peak roughness and the surface roughness were reduced to a significantly larger extent in the treated engine as compared to the un-treated engine. In the data the consistent diameter growth of 0.0002 inch for each cylinder is expected. However, the reduction of the roughness after running the engines is indicative of the additive's ability to coat and protect the contacting surfaces.

The tests were performed for the presence of the additive in/on the surface of the cylinder block halves, rod caps and the outside edge of the compression ring from the piston. The following figures illustrate well the difference between the coated, i.e. treated, and the uncoated, i.e. untreated engine in various surfaces thereof.

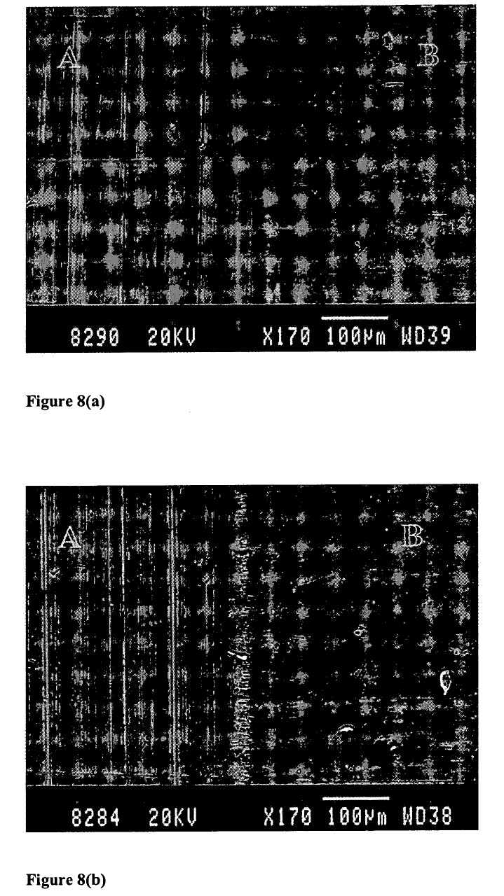

FIG. 8 (a) shows the borderline between sections A and B for the treated engine shown in FIG. 2, while FIG. 8 (b) shows the equivalent borderline for the untreated engine shown in FIG. 3. The vertical striations (A) are the machine marks from the manufacturing process. The movement of the piston is from left to right (B). As visible, section B in the treated engine according to FIG. 8 (a) is much smoother than in FIG. 8 (b). Also notable are pittings, tears and gouges in FIG. 8 (b) at the lower dead center of the uncoated engine that are believed to demonstrate a significant difference between the coated and uncoated cylinder walls. In the uncoated cylinder wall, the piston ring and cylinder wall kind of melt together at the lower dead center and when moving again, digs out some aluminum from the cylinder wall. The coating in FIG. 8 (a) prevents the direct metal-to-metal contact between piston ring and cylinder wall and shows therefore no pittings at all at the lower dead center.

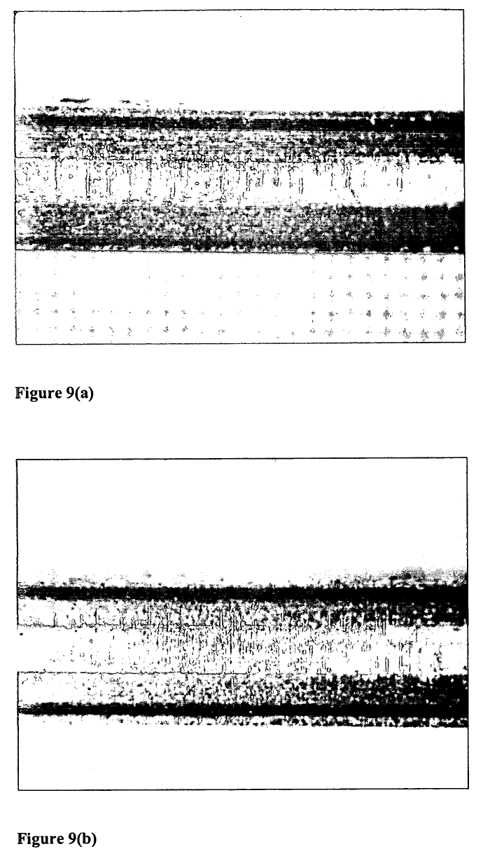

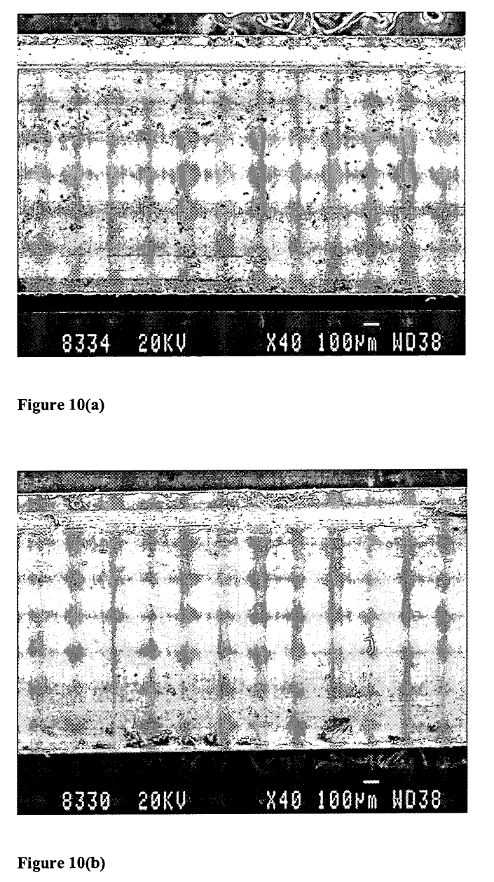

This coincides with FIG. 9 (a) and (b) and 10 (a) and (b) showing the piston ring. In FIG. 9 (a) showing the coated engine the abrasion strip in the middle which is an indicator of direct metal-to-metal contact at least at the peaks of the roughness is much narrower than in FIG. 9 (b) showing the piston ring in the uncoated engine. In FIG. 9 (b) basically the entire piston ring shows some shiny section over the entire width, while the piston ring in FIG. 9 (a) shows a strong contrast between the narrow shiny strip and the dark, non-abrasion strips where the shiny strip is sandwiched in between. This difference becomes even more apparent in FIG. 10 (a) and (b) showing that in the untreated engine the piston ring suffered abrasion over basically the entire width and even shows some aluminum particles that are believed to come from the pittings dug out at the lower dead center as explained with reference to FIG. 8 (b), contrary to the piston ring in FIG. 10 (a) of the treated engine showing very little abrasion and no little aluminum chips or particles are visible.

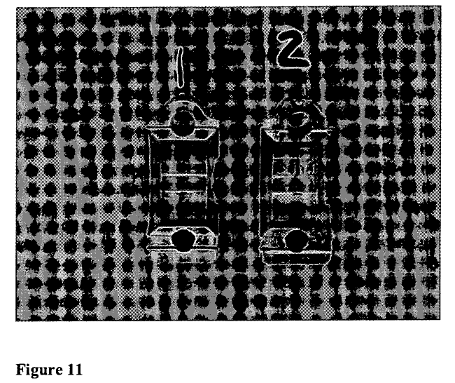

FIG. 11 shows the rod caps embracing the crank shaft, the much smoother surface on the rod cap denoted 1 belonging to the treated engine, while the surface of the rod cap denoted 2 shows significant wash marks as a result of abrasion.

1. An engine part coating made of a heat-activated polyhydrocarbylsiloxane, said coating comprising at least a 5% silicon component above baseline in a volume defined between the surface of the engine part and a depth of 1 micron underneath the surface.

2. The coating of claim 1, wherein the silicon component percentage is at least 10% above baseline.

3. The coating of claim 1, wherein the polyhydrocarbylsiloxane is one of the following: polydialkylsiloxane, polydiphenylsiloxane, or polydimethylpolysiloxane.

4. The coating of claim 3, wherein the polyhydrocarbylsiloxane is polyether- or polyester-modified.

5. The coating of claim 1, wherein it is created by an oil- or fuel additive.

6. The coating of claim 1 formed by the following process steps: a) dispersing the polyhydrocarbylsiloxane in a lubricant; b) bringing the lubricant into contact with certain surface areas inside an engine, c) subjecting the polyhydrocarbylsiloxane to such a temperature that it forms a silicon-containing coating on the contacted engine parts.

7. The coating of claim 6, wherein the percentage of the polydialkylsiloxane dispersed in said lubricant is 0.5 to 2.5% by volume.

8. The coating of claim 6, wherein the temperature is above 300 F (149 C) when applied to a surface to be coated.

9. The coating of claim 6, wherein the temperature is above 345 Fahrenheit (174 C).

10. The coating of claim 6, wherein the temperature is between 345 and 2000 Fahrenheit (174 C-1093 C).

11. The coating of claim 6, wherein the temperature is between 345 and 425 Fahrenheit (174-218 C).

12. The coating of claim 6, when applied to a cylinder wall, reduces the roughness in the in the travel range of a piston ring to one fourth or less of the initial roughness of the cylinder wall as machined.

13. The coating of claim 4, wherein said polyether- or polyester-modified polydialkylsiloxane is represented by the general formula 1 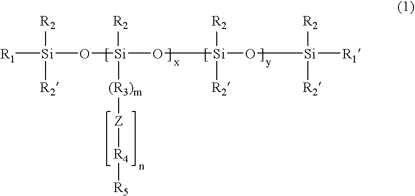
wherein
Z is independently selected from O, 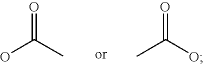
R₁ and R_{1′} are independently selected from C₁-C₆ alkyl and -Z-(C₁-C₆ alkyl)
R₂ and R_{2′} are independently selected from C₁-C₆ alkyl;
R₃ is —(C(R₆)(R₇))—;
R₄ is —(C(R₈)(R₉))ᵥ—;
R₅ is selected from hydrogen, —O—(C₁-C₆-alkyl) and C₁-C₆ alkyl;
R₆, R₇, R₈ and R₉ are independently selected from hydrogen and C₁-C₆ alkyl;
n is an integer from 1 to 10;
m is an integer from 0 to 5;
v is an integer from 1 to 4;
x is an integer from 1 to 150; and
y is an integer from 1 to 500.

14. The coating of claim 13, wherein said C₁-C₆ alkyl comprises methyl, ethyl, propyl, butyl, pentyl and isomers thereof.

15. The coating of claim 13, wherein R₁, R_{1′}, R₂ and R_{2′} are methyl.

16. An engine part coating created from polysiloxanes, said coating comprising one or more of the following compounds: cross-linked polymer made of polysiloxanes; silica; silicon-carbide-oxide; and silicon nitride.

17. The coating of claim 16, wherein the polysiloxane is a polyhydrocarbylsiloxane.

18. The coating of claim 17, wherein the polyhydrocarbylsiloxane is one of the following: polydialkylsiloxane, polydiphenylsiloxane, or polydimethylsiloxane.

19. The coating of claim 18, wherein the polyhydrocarbylsiloxane is polyether- or polyester-modified.

20. The coating of claim 19, wherein it is created by an oil- or fuel additive.

21. A method for coating engine parts comprising the following method steps: a) dispersing polysiloxane in a lubricant; b) bringing the lubricant into contact with certain surface areas inside an engine, c) subjecting the polysiloxane to such a temperature that it forms a silicon-containing coating on the contacted engine parts.

22. The method of claim 21, wherein the polysiloxane is a polyhydrocarbylsiloxane.

23. The method of claim 22, wherein the polyhydrocarbylsiloxane is one of the following: polydialkylsiloxane, polydiphenylsiloxane, or polydimethylsiloxane.

24. The method of claim 23, wherein the polyether- or polyester-modified polyhydrocarbylsiloxane is applied as an oil additive to the motor oil of a combustion engine in a ratio of at least 1:200 by volume.

25. The method of claim 24, wherein the ratio is at least 1:100 by volume.

26. The method of claim 23, wherein the polyether- or polyester-modified polyhydrocarbylsiloxane is applied as a fuel additive to the motor oil of a combustion engine in a ratio of more than 1:100 by volume.

27. The method of claim 26, wherein the ratio is more that 1:60.

28. Use of polysiloxane as a fuel- or oil additive in a combustion engine in a ratio of at least 1:200 by volume.

29. The use of claim 28, wherein the combustion engine is a 2-stroke engine, a 4-stroke engine, or a diesel engine.

30. The use of claim 29, wherein the polysiloxane is a polyhydrocarbylsiloxane.

31. The use of claim 30, wherein the polyhydrocarbylsiloxane is one of the following: polydialkylsiloxane, polydiphenylsiloxane, or polydimethylsiloxane.

32. The use of claim 31, wherein the polyhydrocarbylsiloxane is polyether- or polyester-modified.
